(19) United States
(12) Patent Application Publication
(10) Pub. No.: US 2025/0239677 A1
(43) Pub. Date: Jul. 24, 2025

(54) FAN CONTROL METHOD, APPARATUS, COMPUTER DEVICE, AND NON-TRANSITORY STORAGE MEDIUM

(71) Applicant: SHENZHEN HELLO TECH ENERGY CO., LTD, Longhua Dist. Shenzhen (CN)

(72) Inventors: Hongliang ZHAO, Shenzhen (CN); Xinxin AN, Shenzhen (CN); Feiyan LUO, Shenzhen (CN); Gaosong SHEN, Shenzhen (CN); Qingbin LIN, Shenzhen (CN); Wenhai LIN, Shenzhen (CN)

(21) Appl. No.: 19/174,957

(22) Filed: Apr. 10, 2025

Related U.S. Application Data
(63) Continuation of application No. PCT/CN2023/109623, filed on Jul. 27, 2023.

(30) Foreign Application Priority Data
Oct. 10, 2022 (CN) 202211231650.8

(51) Int. Cl. H01M 10/635; H01M 10/613

(52) U.S. Cl. CPC H01M 10/635; H01M 10/613

(57) ABSTRACT

A fan control method, an apparatus, a computer device, and a storage medium. The method is applied to an energy storage system including a battery pack, a fan configured to cool the battery pack, and a temperature detection unit configured to detect an ambient temperature and a temperature of the battery pack. The method includes: acquiring the ambient temperature and a charge/discharge rate of the battery pack; determining a first temperature interval [T1, T2] of the battery pack according to the ambient temperature, wherein within the first temperature interval, the fan operates with a linear rule for a duty ratio between 0 and A% according to the charge/discharge rate, and 0<A%≤100%; acquiring a current temperature of the battery pack; and if the current temperature is within the first temperature interval, controlling the fan to operate at a preset duty ratio according to the linear rule.

The present disclosure claims the priority of the Chinese Patent Application No. 202211231650.8, filed with the China National Intellectual Property Administration on Oct. 10, 2022, the content of which is incorporated herein by reference in its entirety.

### TECHNICAL FIELD

The present application relates to the technical field of heat dissipation for a battery pack, and for example, relates to a fan control method, an apparatus, a computer device, and a non-transitory storage medium.

### BACKGROUND

At present, with the increase in energy density of a portable energy storage device (such as lithium battery), natural heat dissipation can no longer meet the requirements, and it is necessary to introduce a fan for forced air cooling. It has been realized by the inventors that since the forced air cooling strategy by the fan only takes into account the temperature of the battery cells of the energy storage device and does not consider the external ambient temperature, although this can improve the heat dissipation capacity to a certain extent, it also brings about larger noise, resulting in a poor user experience.

### SUMMARY

The present application provides a fan control method, an apparatus, a computer device, and a non-transitory storage medium, which comprehensively consider the external ambient temperature and the temperature of a battery pack to control the duty ratio of a fan, so as to realize sufficient heat dissipation for the battery pack and the low-noise control of the fan.

In a first aspect, an embodiment of the present application provides a fan control method. The method is applied to an energy storage system, which includes a battery pack, a fan, and a temperature detection unit; where the fan is configured to cool the battery pack, the temperature detection unit is configured to detect an ambient temperature and a temperature of the battery pack, and the fan control method includes:
acquiring the ambient temperature and a charge/discharge rate of the battery pack;
determining a first temperature interval [T1, T2] of the battery pack according to the ambient temperature, where within the first temperature interval [T1, T2] of the battery pack, the fan operates with a linear rule for a duty ratio between 0 and A % according to the charge/discharge rate of the battery pack, and 0<A%≤100%;
acquiring a current temperature of the battery pack; and
in response to the current temperature of the battery pack being within the first temperature interval [T1, T2] of the battery pack, controlling the fan to operate at a preset duty ratio according to the linear rule for the duty ratio between 0 and A%.

In a second aspect, an embodiment of the present application further provides a fan control apparatus including:
a first acquisition module configured to acquire an ambient temperature and a charge/discharge rate of a battery pack;
a first temperature interval determination module configured to determine a first temperature interval [T1, T2] of the battery pack according to the ambient temperature, where within the first temperature interval [T1, T2] of the battery pack, the fan operates in a linear rule for a duty ratio between 0 and A% according to the charge/discharge rate of the battery pack, and 0<A%≤100%;
a second acquisition module configured to acquire a current temperature of the battery pack; and
a fan control module configured to control, in response to the current temperature of the battery pack being within the first temperature interval [T1, T2] of the battery pack, the fan to operate at a preset duty ratio according to the linear rule for the duty ratio between 0 and A%.

In a third aspect, an embodiment of the present application further provides a computer device including a memory, a processor, and a computer program stored in the memory and executable on the processor, where when executing the computer program, the processor implements the fan control method as described in the first aspect.

In a fourth aspect, an embodiment of the present application further provides a non-transitory storage medium including computer executable instructions, where when executed by a computer processor, the computer executable instructions are configured to perform the fan control method as described in the first aspect.

With the technical solutions of the present application, it is possible to achieve the some beneficial technical effects, such as comprehensive consideration for effective heat dissipation, low noise control of the fan, over-temperature protection for the battery pack.

### BRIEF DESCRIPTION OF DRAWINGS

FIG. 1 is a flowchart of a fan control method provided by an embodiment of the present application;

FIG. 2 is a flowchart of another fan control method provided by an embodiment of the present application;

FIG. 3 is a structural schematic diagram of a fan control apparatus provided by an embodiment of the present application; and

FIG. 4 is a structural schematic diagram of a computer device provided by an embodiment of the present application.

### DESCRIPTION OF EMBODIMENTS

The present application is described below in conjunction with the accompanying drawings and embodiments. It may be understood that the embodiments described herein are merely used to explain the present application. Moreover, it should be noted that for the convenience of description, only the parts related to the present application, rather than all the structures, are shown in the accompanying drawings.

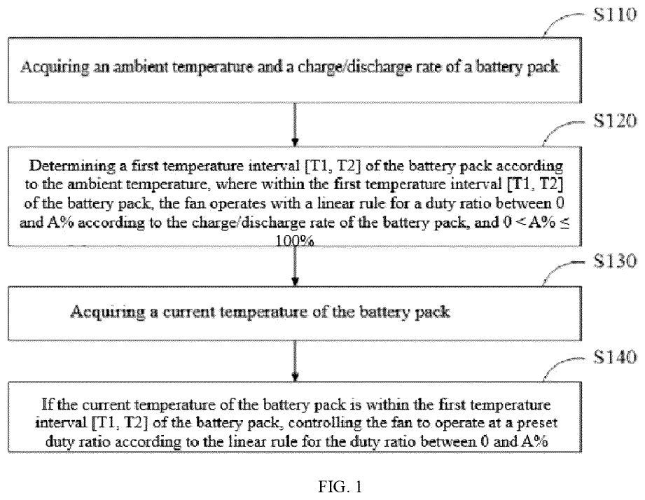

FIG. 1 is a flowchart of a fan control method provided by an embodiment of the present application. As shown in FIG. 1, the method may include steps of:

S110: acquiring an ambient temperature and a charge/discharge rate of a battery pack.

Where the method is applied to an energy storage system, which includes the battery pack, a fan, and a temperature detection unit; the fan is configured to cool the battery pack; the temperature detection unit is configured to detect the ambient temperature and the temperature of the battery pack; and the temperature detection unit may be a thermistor. In this embodiment, the temperature of the battery pack can be detected by the temperature detection unit. It should be noted that during a charging process and a discharging process of the battery pack, the temperature distribution at various detection sites of the battery pack detected by the temperature detection unit is uneven. In some embodiments, a plurality of temperatures of the battery pack may be detected, and a maximum value among the plurality of temperatures of the battery pack is selected as the temperature of the battery pack.

The charge/discharge rate of the battery pack determines the amount of heat generated by the battery pack, and the heat dissipation efficiency of the fan varies according to the variation of the amount of heat generated by the battery pack. Generally, the higher the charging/discharging rate of the battery pack, the more heat is generated by the battery pack during the charging process and the discharging process, and thus the fan is required to have a larger heat dissipation efficiency; and the lower the charging/discharging rate of the battery pack, the less heat is generated by the battery pack during the charging process and the discharging process, and thus the fan is required to have a smaller heat dissipation efficiency. In this embodiment, the amount of heat generated by the battery pack is determined by acquiring the charging/discharging rate of the battery pack, so as to determine the magnitude of the heat dissipation efficiency which the fan is required to have.

S120: determining a first temperature interval [T1, T2] of the battery pack according to the ambient temperature, where within the first temperature interval [T1, T2] of the battery pack, the fan operates with a linear rule for a duty ratio between 0 and A% according to the charge/discharge rate of the battery pack, and 0<A%≤100%.

Where when the temperature of the battery pack is within the first temperature interval [T1, T2] of the battery pack, the fan is controlled to operate in the linear rule for the duty ratio between 0 and A%. That is, when the temperature of the battery pack is T1, the fan is started; subsequently, when the temperature of the battery pack gradually increases from T1 to T2, the duty ratio of the fan increases linearly; and when the temperature of the battery pack is T2, the fan operates at a maximum duty ratio A. It can be understood that the higher the charging/discharging rate of the battery pack, the more heat is generated by the battery pack, and thus the fan is required to have a larger heat dissipation efficiency, and the set greater maximum duty ratio A can effectively dissipate heat for the battery pack. That is, when the charge/discharge rate of the battery pack is higher, Ain the linear rule for the duty ratio between 0 and A% is greater.

Generally, the fan will directly adjust and control its duty cycle directly based on the temperature [0-Tmax] of the battery pack to achieve the purpose of heat dissipation of the battery pack. Although this can improve the heat dissipation capacity to a certain extent, at the same time this will relatively bring noise. As the ambient temperature may affect the heat dissipation efficiency of the battery pack, in the case where the fan rotates at the same speed, the higher the ambient temperature, the lower the heat dissipation efficiency of the battery pack. Therefore, the duty cycle of the fan is required to comprehensively consider both the ambient temperature and the temperature of battery pack. In this embodiment, a different first temperature interval [T1, T2] of the battery pack is determined from a different ambient temperature, so that when the temperature of the battery pack reaches a different T1, the fan is started, the speed of the fan is linearly adjusted within the temperature (T1, T2) of the battery pack, and when the temperature of the battery pack reaches a different T2, the speed of the fan is adjusted at the maximum duty ratio. As such, the external ambient temperature and the temperature of the battery pack can be comprehensively considered, the fan is subjected to preset duty ratio control, and the sufficient heat dissipation of the battery pack is realized; and in addition, under a different ambient temperature, the fan is started when the temperature of the battery pack reaches a different T1, so that the fan is prevented from being in a starting process all the time, and the low-noise control of the fan is realized.

S130: acquiring a current temperature of the battery pack.

The current temperature of the battery pack can be the maximum temperature of the battery pack among a plurality of temperatures of the battery pack detected at a plurality of detection points; and the current temperature of the battery pack is a maximum temperature of the battery pack during the charging process of the battery pack or the discharging process of the battery pack.

S140: if the current temperature of the battery pack is within the first temperature interval [T1, T2] of the battery pack, controlling the fan to operate at a preset duty ratio according to the linear rule for the duty ratio between 0 and A%.

Where when the current temperature of the battery pack is within the first temperature interval [T1, T2] of the battery pack, the fan is controlled to operate at a preset duty ratio according to the linear rule for the duty ratio between 0 and A%, thereby realizing sufficient heat dissipation for the battery pack and low-noise control of the fan.

Optionally, if the current temperature of the battery pack exceeds a second temperature interval [T3, T4], the battery pack stops operating, where the second temperature interval [T3, T4] includes the first temperature interval [T1, T2] of the battery pack, and the battery pack operates safely in the second temperature interval [T3, T4].

If the current temperature of the battery pack is within a temperature interval (T2, T4], the fan operates at a duty ratio of A%.

If the current temperature of the battery pack is greater than T4, it is judged whether a charging signal is detected, and if the charging signal is detected, the fan is controlled to operate at a duty ratio of B%; where 0<B%≤100%.

Where in the operation process of the battery pack, if the current temperature of the battery pack exceeds the second temperature interval [T3, T4], the battery pack stops operating, which can achieve over-temperature protection for the battery pack, thereby avoiding combustion and explosion of the battery pack. After the battery pack stops operating, that is, after over-temperature protection, if the charging signal is detected, the fan is controlled to operate at the duty ratio of B%, so that cooling can be accelerated. In an embodiment, if the charging signal is detected, the fan is controlled to operate at a duty ratio of 50%, so that cooling can be accelerated, and the subsequent charging speed of the battery pack can be increased.

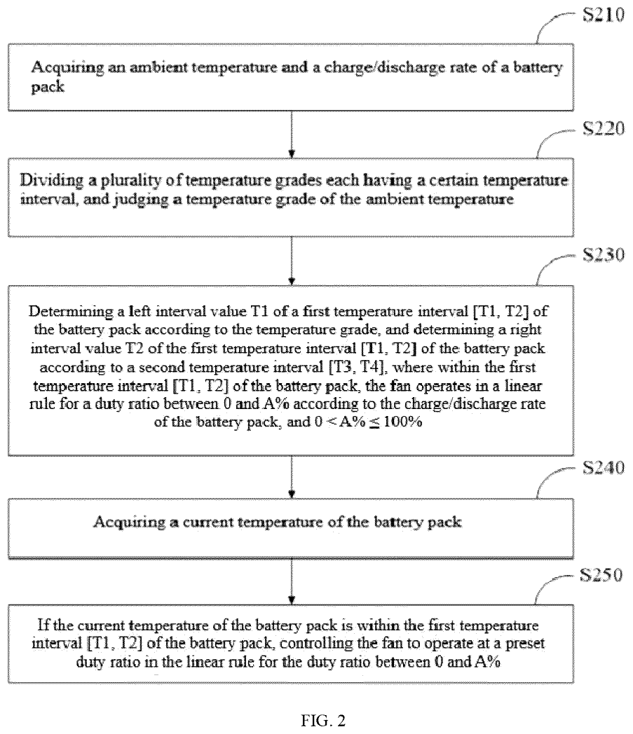

Optionally, based on the above embodiments, how to determine the first temperature interval [T1, T2] of the battery pack according to the ambient temperature is described. FIG. 2 is a flowchart of another fan control method provided by an embodiment of the present application. As shown in FIG. 2, the method includes:

S210: acquiring an ambient temperature and a charge/discharge rate of a battery pack.

S220: dividing a plurality of temperature grades each having a certain temperature interval, and judging a temperature grade of the ambient temperature.

According to the heat dissipation efficiency of the battery pack, a plurality of temperature grades each having a certain temperature interval are divided (for example, the temperature grades may be represented by Roman numbers, and the temperature grades may include grade I, grade II, grade III, etc.). That is, at a different temperature grade, the heat dissipation efficiency of the battery pack is different. Generally, in the case of there is no heat dissipation by the fan or when the fan rotates at the same speed, the higher the temperature grade, the lower the heat dissipation efficiency of the battery pack; and when the temperature grade reaches a preset temperature grade, the heat dissipation efficiency of the battery pack is lowest. In order to achieve effective heat dissipation for the battery pack, when the temperature grade is higher, the heat dissipation efficiency of the battery pack is lower, and the fan is required to have higher heat dissipation efficiency.

In an embodiment, the preset temperature grade may be one of the above-mentioned plurality of temperature grades each having a certain temperature interval.

S230: determining a left interval value T1 of a first temperature interval [T1, T2] of the battery pack according to the temperature grade, and determining a right interval value T2 of the first temperature interval [T1, T2] of the battery pack according to a second temperature interval [T3, T4], where within the first temperature interval [T1, T2] of the battery pack, the fan operates in a linear rule for a duty ratio between 0 and A% according to the charge/discharge rate of the battery pack, and 0<A%≤100%.

In an actual fan control process, the right interval value T2 of the first temperature interval [T1, T2] of the battery pack only needs to be less than the right interval value T4 of the second temperature interval [T3, T4]. The right interval value T2 of the first temperature interval [T1, T2] of the battery pack determines the end time of fan control. Generally, at different ambient temperature grades, the right interval value T2 of the first temperature interval [T1, T2] of the battery pack is constant. That is, at different ambient temperature grades, the end time of fan control is substantially the same. The magnitude of the left interval value T1 of the first temperature interval [T1, T2] of the battery pack determines the start time of the fan. Under the condition that the end time of the fan is fixed, the earlier the start time of the fan, the longer the operating time of the fan, and the higher the heat dissipation efficiency of the fan; while the shorter the operating time of the fan, the lower the heat dissipation efficiency of the fan.

Since the higher the temperature grade, the lower the heat dissipation efficiency of the battery pack, and the fan is required to have a higher heat dissipation efficiency. Exemplarily, in this embodiment, when the temperature grade at which the ambient temperature is located is less than or equal to the preset temperature grade, the higher the temperature grade, the lower the left interval value T1 of the first temperature interval [T1, T2] of the battery pack, and the longer the operating time of the fan, the higher the heat dissipation efficiency of the fan. When the temperature grade at which the ambient temperature is located is greater than or equal to the preset temperature grade, because the temperature grade of the ambient temperature reaches the preset temperature grade and the heat dissipation efficiency of the battery pack is the lowest, compared with extending the operating time of the fan to improve the heat dissipation efficiency of the fan, a ratio of fan duty cycle to temperature change has a greater impact on the heat dissipation efficiency of the fan. When the temperature grade of the ambient temperature is greater than the preset temperature grade, the left interval value T1 of the first temperature interval [T1, T2] of the battery pack is adjusted, so that a ratio of fan duty cycle to temperature change of the battery pack is greater than a ratio of fan duty cycle to temperature change determined at a temperature grade preceding the preset temperature grade, which can achieve sufficient heat dissipation for the battery pack. Where the ratio of fan duty cycle to temperature change of the battery pack is: a ratio of A% to the difference (T2-T1) within the first temperature interval [T1, T2] of the battery pack. In addition, since the fan is started when the temperature of the battery pack reaches a different T1 at each of the temperature grades, the fan is avoided from being in the started process all the time at each of temperature grades, and also low-noise control of the fan is realized.

It should also be noted that the operation process of the battery pack includes a charging process of the battery pack and a discharging process of the battery pack. In this embodiment, after acquiring the ambient temperature and the charge/discharge rate of the battery pack, optionally, the method further includes: judging a charging state or a discharging state of the battery pack; when the battery pack is in the charging state, determining a I type of the first temperature interval of the battery pack according to the ambient temperature, where within the I type of the first temperature interval of the battery pack, the fan operates in the linear rule for the duty ratio between 0 and A% according to the charging efficiency of the battery pack, and 0<A%≤100%; and when the battery pack is in the discharging state, determining a II type of the first temperature interval of the battery pack according to the ambient temperature, where within the II type of the first temperature interval of the battery pack, the fan operates in the linear rule for the duty ratio between 0 and A % according to the charging efficiency of the battery pack, and 0<A%≤100%.

In the tables below, the adjustment of the duty ratio of the fan in the charging process of the battery pack and the discharging process of the battery pack are illustrated respectively:

TABLE 1
Control of the duty ratio of the fan in the charging process of the battery pack

| | I type of a second temperature | | | | |
|---|---|---|---|---|---|
| | interval [T3, T4] − [0-50° C.] of the | | | | |
| | battery pack | | | | |
| | Lowest | Highest | I type of the first | | Ratio of fan |
| Ambient | temperature | temperature | temperature interval | Fan | duty cycle to |
| Temperature | of the | of the | [T1, T2] of the | duty | temperature |
| Grade | battery pack | battery pack | battery pack | ratio | change |
| Grade I | 0° C. | 50° C. | 40° C.-45° C. | 0-A % | |
| [0° C., 10° C.) | | | | | |
| Grade II | 0° C. | 50° C. | 30° C.-45° C. | 0-A % | |
| [10° C., 25° C.) | | | | | |
| Grade III | 0° C. | 50° C. | 28° C.-45° C. | 0-A % | A %/17 |
| [25° C., 35° C.) | | | | | |
| Grade IV | 0° C. | 50° C. | 35° C.-45° C. | 0-A % | A %/10 |
| [35° C., 50° C.] | | | | | |

As can be seen from Table 1: when the battery pack is in the charging state, different I type of the first temperature intervals of the battery packs are determined according to different ambient temperatures; when the temperature grade of the ambient temperature is less than or equal to the preset temperature grade, exemplarily, taking the preset temperature grade as grade III as an example, when the temperature grade is at grade I [0C, 10° C.), grade II [10° C., 25° C.) or grade III [25° C., 35° C.), the left interval value of the I type of the first temperature interval of the battery pack is related to the temperature grade, and as the temperature grade increases, the left interval value T1 of the I type of the first temperature interval [T1, T2] of the battery pack is lower; while when the temperature grade is greater than the preset temperature grade, exemplarily, still taking the preset temperature grade as grade III as an example, when the temperature grade is at grade IV [35° C., 50° C.], the left interval value T1 of the I type of the first temperature interval [T1, T2] of the battery pack can be adjusted, so that the ratio off an duty cycle to temperature change (such as A%/10 in Table 1) at the temperature grade [35° C.-50° C.] is greater than the ratio of fan duty cycle to temperature change (such as A%/17 in Table 1) determined at the temperature grade [25° C., 35° C.) preceding the preset temperature grade, so as to achieve effective heat dissipation for the battery pack in the charging process.

TABLE 2
Control of the duty ratio of the fan in the discharging process of the battery pack

| | II type of the second temperature | | | | |
|---|---|---|---|---|---|
| | interval [T3, T4] − [−10-60° C.] of the | | | | |
| | battery pack | | | | |
| | Lowest | Highest | II type of the first | | Ratio of fan |
| Ambient | temperature | temperature | temperature interval | Fan | duty cycle to |
| Temperature | of the | of the | [T1, T2] of the | duty | temperature |
| Grade | battery pack | battery pack | battery pack | ratio | change |
| Grade I | −10° C. | 60° C. | 45° C.-55° C. | 0-A % | |
| [−10° C., 0° C.) | | | | | |
| Grade II | −10° C. | 60° C. | 40° C.-55° C. | 0-A % | |
| [0° C., 15° C.) | | | | | |
| Grade III | −10° C. | 60° C. | 35° C.-55° C. | 0-A % | |
| [15° C., 30° C.) | | | | | |
| Grade IV | −10° C. | 60° C. | 30° C.-50° C. | 0-A % | A %/20 |
| [30° C., 40° C.) | | | | | |
| Grade V | −10° C. | 60° C. | 40° C.-45° C. | 0-A % | A %/5 |
| [40° C., 60° C.] | | | | | |

As can be seen from Table 2: when the battery pack is in the discharging state, different II type of the first temperature intervals of the battery packs are determined according to different ambient temperatures; when the temperature grade at which the ambient temperature is located is less than or equal to the preset temperature grade, exemplarily, taking the preset temperature grade as grade IV as an example, when the temperature grade is at grade I [−10° C., 0° C.), grade II [0° C., 15° C.), grade III [15° C., 30° C.), and grade IV [30° C., 40° C.), the left interval value of the II type of the first temperature interval of the battery pack is related to the temperature grade, and as the temperature grade increases, the left interval value T1 of the first temperature interval [T1, T2] of the battery pack is lower; when the temperature grade is greater than the preset temperature grade, exemplarily, still taking the preset temperature grade as grade IV as an example, when the temperature grade is at grade V [40° C., 60° C.], the left interval value of the first temperature interval [T1, T2] of the battery pack can be adjusted, so that the ratio of fan duty cycle to temperature change (such as A%/5 in Table 2) at the temperature grade is greater than the ratio of fan duty cycle to temperature change (such as A%/20 in Table 2) determined at the temperature grade IV [30° C., 40° C.) preceding the temperature grade, so as to achieve effective heat dissipation for the battery pack in the discharging process.

S240: acquiring a current temperature of the battery pack.

S250: if the current temperature of the battery pack is within the first temperature interval [T1, T2] of the battery pack, controlling the fan to operate at a preset duty ratio in the linear rule for the duty ratio between 0 and A%.

In this solution, on the basis of the above-mentioned solutions, in the operation process of the battery pack, the left interval value T1 of the first temperature interval [T1, T2] of the battery pack is determined according to the temperature grade, and the right interval value T2 of the first temperature interval [T1, T2] of the battery pack is determined according to the second temperature interval [T3, T4]. Therefore, different first temperature intervals [T1, T2] of the battery pack are determined according to different ambient temperatures, so that the fan is started when the temperature of the battery pack reaches a different T1, the speed of the fan is linearly adjusted within the temperature T1-T2 of the battery pack, and the speed of the fan is adjusted at the maximum duty ratio when the temperature of the battery pack reaches a different T2. As such, by comprehensively considering the external ambient temperature and the temperature of the battery pack, the fan can be controlled with the preset duty cycle, achieving sufficient heat dissipation for the battery pack and low-noise control of the fan.

In addition, it should also be noted that since the operation process of the battery pack includes the charging process of the battery pack and the discharging process of the battery pack, the second temperature interval [T3, T4] includes the I type of the second temperature interval and a II type of the second temperature interval. Optionally, if the current temperature of the battery pack exceeds the I type of the second temperature interval or the II type of the second temperature interval, the battery pack stops operating; where the I type of the second temperature interval includes the I type of the first temperature interval of the battery pack. The battery pack is safely charged in the I type of the second temperature interval. The II type of the second temperature interval includes the II type of the first temperature interval of the battery pack. The battery pack is safely discharged in the II type of the second temperature interval.

Where with continued reference to Table 1, when the battery pack is in the charging process, if the current temperature of the battery pack exceeds the I type of the second temperature interval [0° C., 50° C.], the battery pack stops operating, so as to achieve over-temperature protection in the charging process of the battery pack. That is, the charging safety temperature range of the battery pack is [0° C., 50° C.]. With continued reference to Table 2, when the battery pack is in the discharging process, if the current temperature of the battery pack exceeds the II type of the second temperature interval [−10° C., 60° C.], the battery pack stops operating, so as to achieve over-temperature protection in the discharging process of the battery pack. That is, the discharging safety temperature range of the battery pack is [−10° C., 60° C.].

An embodiment of the present application further provides a fan control apparatus. The fan control apparatus provided by the embodiment of the present application can execute the fan control method provided by any of the embodiments of the present application, and has corresponding functional modules to execute the method and beneficial effects. FIG. 3 is a structural schematic diagram of a fan control apparatus provided by an embodiment of the present application. As shown in FIG. 3, the apparatus includes:
a first acquisition module 10 configured to acquire an ambient temperature and a charge/discharge rate of a battery pack;
a first temperature interval determination module 20 configured to determine a first temperature interval [T1, T2] of the battery pack according to the ambient temperature, where within the first temperature interval [T1, T2] of the battery pack, the fan operates in a linear rule for a duty ratio between 0 and A% according to a charge/discharge rate of the battery pack, and 0<A%≤100%;
a second acquisition module 30 configured to acquire a current temperature of the battery pack; and
a fan control module 40 configured to control, in response to the current temperature of the battery pack being within the first temperature interval [T1, T2] of the battery pack, the fan to operate at a preset duty ratio according to the linear rule for the duty ratio between 0 and A%.

Optionally, the apparatus further includes:
an operation-stop module configured to stop operation of the battery pack when the current temperature of the battery pack exceeds a second temperature interval [T3, T4], where the second temperature interval [T3, T4] includes the first temperature interval [T1, T2] of the battery pack, and the battery pack operates safely in the second temperature interval [T3, T4]; and
a first preset duty ratio operation module configured to operate the fan at a duty ratio of A% when the current temperature of the battery pack is within a temperature interval (T2, T4].

Optionally, the apparatus further includes:
a first judging module configured to judge whether a charging signal is detected when the current temperature of the battery pack is greater than T4; and
a second preset duty ratio operation module configured to control the fan to operate at a duty ratio of B% when the charging signal is detected; where 0<B%≤100%.

Optionally, the apparatus further includes:
a second judging module configured to divide a plurality of temperature grades each having a certain temperature interval, and to judge a temperature grade at which the ambient temperature is located;
a first temperature interval determination module 20 includes:
a left interval determining unit configured to determine a left interval value T1 of the first temperature interval [T1, T2] of the battery pack according to the temperature grade;
a right interval determining unit configured to determine a right interval value T2 of the first temperature interval [T1, T2] of the battery pack according to the second temperature interval [T3, T4]; and
a first temperature interval determining unit configured to determine the first temperature interval [T1, T2] of the battery pack according to the left interval value T1 and the right interval value T2.

Optionally, a ratio of fan duty cycle to temperature change is: a ratio of the duty ratio of A% to a temperature range (T2-T1) of the first temperature interval [T1, T2] of the battery pack.

Optionally, the left interval determining unit is configured to determine the left interval value T1 of the first temperature interval [T1, T2] of the battery pack according to the temperature grade in the following manner:
when the temperature grade is less than or equal to the preset temperature grade, the higher the temperature grade, the lower the left interval value T1 of the first temperature interval [T1, T2] of the battery pack; where the heat dissipation efficiency of the battery pack is the lowest at the preset temperature grade;
when the temperature grade is greater than the preset temperature grade, the left interval value T1 of the first temperature interval [T1, T2] of the battery pack is adjusted, so that the ratio of fan duty cycle to temperature change is greater than the ratio of fan duty cycle to temperature change determined at the temperature grade preceding the preset temperature grade.

Optionally, the second preset duty ratio operation module is configured to control the fan to operate at the duty ratio of B% by:
controlling the fan to operate at a duty ratio of 50%.

Optionally, the fan operating in a linear rule for a duty ratio between 0 and A% according to the charge/discharge rate of the battery pack specifically is:
when the charge/discharge rate of the battery pack is higher, the A in the linear rule for the duty ratio between 0 and A% is greater.

Optionally, the apparatus further includes:
a third determination module configured to judge a charging state or a discharging state of the battery pack.

The first temperature interval determination module 20 includes:
a first determining unit configured to determine a I type of the first temperature interval of the battery pack according to the ambient temperature when the battery pack is in the charging state; where within the I type of the first temperature interval of the battery pack, the fan operates in the linear rule for the duty ratio between 0 and A% according to a charging efficiency of the battery pack, and 0<A%≤100%; and
a second determining unit configured to determine a II type of the first temperature interval of the battery pack according to the ambient temperature when the battery pack is in the discharging state; where within the II type of the first temperature interval of the battery pack, the fan operates in the linear rule for the duty ratio between 0 and A % according to a discharge efficiency of the battery pack, and 0<A%≤100%.

Optionally, the second temperature interval [T3, T4] includes a I type of the second temperature interval and a II type of the second temperature interval;

The operation-stop module includes:
an operation-stop unit configured to stop operation of the battery pack when the current temperature of the battery pack exceeds the I type of the second temperature interval or the II type of the second temperature interval; where the I type of the second temperature interval includes the I type of the first temperature interval of the battery pack; and the battery pack is safely charged in the I type of the second temperature interval; and the II type of the second temperature interval includes the II type of the first temperature interval of the battery pack, and the battery pack is safely discharged in the II type of the second temperature interval.

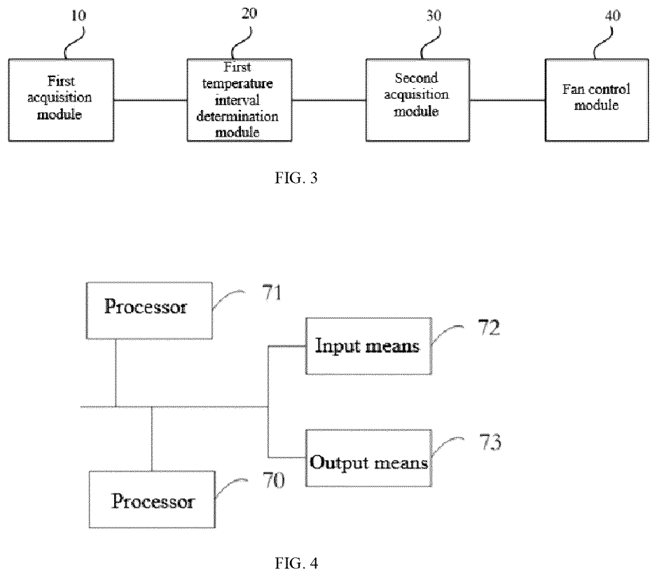

FIG. 4 is a structural schematic diagram of a computer device provided by an embodiment of the present application. As shown in FIG. 4, the device includes a processor 70, a memory 71, an input means 72, and an output means 73. The number of the processor 70 in the device may be one or more. One processor 70 is taken as an example in FIG. 4. The processor 70, the memory 71, the input means 72, and the output means 73 in the device may be connected via a bus or in another manner. Connection via a bus is taken as an example in FIG. 4.

As a computer-readable storage medium, the memory 71 may be configured to store software programs, computer-executable programs, and modules, such as program instructions/modules corresponding to the fan control method in the embodiments of the present application (for example, the first acquisition module 10, the first temperature interval determination module 20, the second acquisition module 30, and the fan control module 40 in the fan control apparatus). The processor 70 executes various functional applications and data processing of the device by running the software programs, instructions, and modules stored in the memory 71, that is, implements the foregoing fan control method.

The memory 71 may mainly include a program storage area and a data storage area, where the program storage area may store an operating system and an application program required by at least one function; and the data storage area may store data created according to usage of a terminal. In addition, the memory 71 may include a high-speed random access memory, and may further include a non-volatile memory, for example, at least one magnetic disk storage device, a flash memory device, or another non-volatile solid-state storage device. In some examples, the memory 71 may include memories provided remotely relative to the processor 70. These remote memories may be connected to the device through a network. Examples of the above network include the internet, an intranet, a local area network, a mobile communication network, and a combination thereof.

The input means 72 may be configured to receive input numeric or character information, and to generate key signal input related to user setting and function control of the device. The output means 73 may include a display device such as a display screen.

An embodiment of the present application further provides a non-transitory storage medium including computer executable instructions. When executed by a computer processor, the computer executable instructions are configured to execute a fan control method. The method includes:
acquiring an ambient temperature and a charge/discharge rate of a battery pack;
determining a first temperature interval [T1, T2] of the battery pack according to the ambient temperature; where within the first temperature interval [T1, T2] of the battery pack, the fan operates with a linear rule for a duty ratio between 0 and A% according to the charge/discharge rate of the battery pack, and 0<A%≤100%;
acquiring a current temperature of the battery pack; and
when the current temperature of the battery pack is within the first temperature interval [T1, T2] of the battery pack, controlling the fan to operate at a preset duty ratio according to the linear rule for the duty ratio between 0 and A%.

Of course, for the non-transitory storage medium including computer executable instructions provided by the embodiment of the present application, the computer executable instructions thereof are not limited to the operation of the method as described above, and may further execute related operations in the fan control method provided by any of the embodiments of the present application.

Through the above description of the implementations, those skilled in the art can clearly understand that the present application can be implemented by software sand necessary general hardware, and of course, can also be implemented by hardware, but in many cases, the former is a better implementation. Based on such a understanding, the technical solutions of the present application essentially or the part that makes contributions to the prior art may be embodied in the form of a software product, and the computer software product may be stored in a computer readable storage medium, such as a floppy disk, a read-only memory (ROM), a random access memory (RAM), a flash memory (FLASH), a hard disk or an optical disk of a computer, and includes at least one instruction to enable a computer device (which may be a personal computer, a server, or a network device) to execute the methods described in the embodiments of the present application.

What is claimed is:

1. A fan control method, which is applied to an energy storage system comprising a battery pack, a fan, and a temperature detection unit, wherein the fan is configured to cool the battery pack; the temperature detection unit is configured to detect an ambient temperature and a temperature of the battery pack, and the fan control method comprises:
acquiring the ambient temperature and a charge/discharge rate of the battery pack;
determining a first temperature interval [T1, T2] of the battery pack according to the ambient temperature, wherein within the first temperature interval [T1, T2] of the battery pack, the fan operates with a linear rule for a duty ratio between 0 and A% according to the charge/discharge rate of the battery pack, and 0<A%≤100%;
acquiring a current temperature of the battery pack; and
in response to the current temperature of the battery pack being within the first temperature interval [T1, T2] of the battery pack, controlling the fan to operate at a preset duty ratio according to the linear rule for the duty ratio between 0 and A%.

2. The fan control method according to claim 1, further comprising:
stopping operation of the battery pack in response to the current temperature of the battery pack exceeding a second temperature interval [T3, T4], wherein the second temperature interval [T3, T4] includes the first temperature interval [T1, T2] of the battery pack, and the battery pack operates safely within the second temperature interval [T3, T4]; and
operating the fan at the duty ratio of A% in response to the current temperature of the battery pack being within a temperature interval (T2, T4].

3. The fan control method according to claim 2, further comprising:
determining whether a charging signal is detected in response to the current temperature of the battery pack being greater than T4; and
controlling the fan to operate at a duty ratio of B % in response to detecting the charging signal, wherein 0<B%≤100%.

4. The fan control method according to claim 2, further comprising:
dividing a plurality of temperature grades each having a certain temperature interval, and judging a temperature grade at which the ambient temperature is located;
wherein said determining a first temperature interval [T1, T2] of the battery pack according to the ambient temperature comprises:
determining a left interval value T1 of the first temperature interval [T1, T2] of the battery pack according to the temperature grade;
determining a right interval value T2 of the first temperature interval [T1, T2] of the battery pack according to the second temperature interval [T3, T4]; and
determining the first temperature interval [T1, T2] of the battery pack according to the left interval value T1 and the right interval value T2.

5. The fan control method according to claim 4, wherein said determining a left interval value T1 of the first temperature interval [T1, T2] of the battery pack according to the temperature grade comprises:
when the temperature grade is less than or equal to a preset temperature grade, the higher the temperature grade, the lower the left interval value T1 of the first temperature interval [T1, T2] of the battery pack, wherein the battery pack has a lowest heat dissipation efficiency at the preset temperature grade; and
when the temperature grade is greater than the preset temperature grade, adjusting the left interval value T1 of the first temperature interval [T1, T2] of the battery pack, so that a ratio of fan duty cycle to temperature change of the battery pack at the temperature grade is greater than a ratio of fan duty cycle to temperature change determined at a preceding temperature grade.

6. The fan control method according to claim 5, wherein the ratio of fan duty cycle to temperature change is: a ratio of the duty ratio of A% to a temperature range (T2-T1) of the first temperature interval [T1, T2] of the battery pack.

7. The fan control method according to claim 3, wherein said controlling the fan to operate at a duty ratio of B% comprises:
controlling the fan to operate at a duty ratio of 50%.

8. The fan control method according to claim 1, wherein the fan operating with a linear rule for a duty ratio between 0 and A% according to the charge/discharge rate of the battery pack comprises:
the higher the charge/discharge rate of the battery pack, the greater A in the linear rule for the duty ratio between 0 and A%.

9. The fan control method according to claim 2, further comprising:
judging a charging state or a discharging state of the battery pack;
wherein said determining a first temperature interval [T1, T2] of the battery pack according to the ambient temperature comprises:
determining a I type of the first temperature interval of the battery pack according to the ambient temperature in response to the battery pack being in the charging state, wherein within the I type of the first temperature interval of the battery pack, the fan operates in the linear rule for the duty ratio between 0 and A% according to a charging efficiency of the battery pack, and 0<A%≤100%; and
determining a II type of the first temperature interval of the battery pack according to the ambient temperature in response to the battery pack being in a discharging state, wherein in the II type of the first temperature interval of the battery pack, the fan operates in the linear rule for the duty ratio between 0 and A% according to a discharging efficiency of the battery pack, and 0<A%≤100%.

10. The fan control method according to claim 9, wherein the second temperature interval [T3, T4] comprises a I type of the second temperature interval and a II type of the second temperature interval;
said stopping operation of the battery pack in response to the current temperature of the battery pack exceeding a second temperature interval [T3, T4] comprises:
stopping the operation of the battery pack in response to the current temperature of the battery pack exceeding the I type of the second temperature interval or the II type of the second temperature interval, wherein the I type of the second temperature interval comprises the I type of the first temperature interval of the battery pack, the battery pack is safely charged in the I type of the second temperature interval; and the II type of the second temperature interval comprises the II type of the first temperature interval of the battery pack, and the battery pack is safely discharged within the II type of the second temperature interval.

11. A computer device, comprising a memory, a processor, and a computer program stored in the memory and executable on the processor, wherein when executing the computer program, the processor implements a fan control method, which is applied to an energy storage system comprising a battery pack, a fan, and a temperature detection unit, wherein the fan is configured to cool the battery pack; the temperature detection unit is configured to detect an ambient temperature and a temperature of the battery pack, and the fan control method comprises:
acquiring the ambient temperature and a charge/discharge rate of the battery pack;
determining a first temperature interval [T1, T2] of the battery pack according to the ambient temperature, wherein within the first temperature interval [T1, T2] of the battery pack, the fan operates with a linear rule for a duty ratio between 0 and A% according to the charge/discharge rate of the battery pack, and 0<A%≤100%;
acquiring a current temperature of the battery pack; and
in response to the current temperature of the battery pack being within the first temperature interval [T1, T2] of the battery pack, controlling the fan to operate at a preset duty ratio according to the linear rule for the duty ratio between 0 and A%.

12. The computer device according to claim 11, wherein the processor further implements steps of:
stopping operation of the battery pack in response to the current temperature of the battery pack exceeding a second temperature interval [T3, T4], wherein the second temperature interval [T3, T4] includes the first temperature interval [T1, T2] of the battery pack, and the battery pack operates safely within the second temperature interval [T3, T4]; and
operating the fan at the duty ratio of A% in response to the current temperature of the battery pack being within a temperature interval (T2, T4].

13. The computer device according to claim 12, wherein the processor further implements steps of:
determining whether a charging signal is detected in response to the current temperature of the battery pack being greater than T4; and
controlling the fan to operate at a duty ratio of B % in response to detecting the charging signal, wherein 0<B%≤100%.

14. The computer device according to claim 12, wherein the processor further implements steps of:
dividing a plurality of temperature grades each having a certain temperature interval, and judging a temperature grade at which the ambient temperature is located;
wherein said determining a first temperature interval [T1, T2] of the battery pack according to the ambient temperature comprises:
determining a left interval value T1 of the first temperature interval [T1, T2] of the battery pack according to the temperature grade;
determining a right interval value T2 of the first temperature interval [T1, T2] of the battery pack according to the second temperature interval [T3, T4]; and
determining the first temperature interval [T1, T2] of the battery pack according to the left interval value T1 and the right interval value T2.

15. The computer device according to claim 14, wherein said determining a left interval value T1 of the first temperature interval [T1, T2] of the battery pack according to the temperature grade comprises:
when the temperature grade is less than or equal to a preset temperature grade, the higher the temperature grade, the lower the left interval value T1 of the first temperature interval [T1, T2] of the battery pack, wherein the battery pack has a lowest heat dissipation efficiency at the preset temperature grade; and
when the temperature grade is greater than the preset temperature grade, adjusting the left interval value T1 of the first temperature interval [T1, T2] of the battery pack, so that a ratio of fan duty cycle to temperature change of the battery pack at the temperature grade is greater than a ratio of fan duty cycle to temperature change determined at a preceding temperature grade.

16. The computer device according to claim 13, wherein said controlling the fan to operate at a duty ratio of B% comprises:
controlling the fan to operate at a duty ratio of 50%.

17. The computer device according to claim 11, wherein the fan operating with a linear rule for a duty ratio between 0 and A% according to the charge/discharge rate of the battery pack comprises:
the higher the charge/discharge rate of the battery pack, the greater A in the linear rule for the duty ratio between 0 and A%.

18. The computer device according to claim 12, wherein the processor further implements steps of:
judging a charging state or a discharging state of the battery pack;
wherein said determining a first temperature interval [T1, T2] of the battery pack according to the ambient temperature comprises:
determining a I type of the first temperature interval of the battery pack according to the ambient temperature in response to the battery pack being in the charging state, wherein within the I type of the first temperature interval of the battery pack, the fan operates in the linear rule for the duty ratio between 0 and A% according to a charging efficiency of the battery pack, and 0<A%≤100%; and
determining a II type of the first temperature interval of the battery pack according to the ambient temperature in response to the battery pack being in a discharging state, wherein in the II type of the first temperature interval of the battery pack, the fan operates in the linear rule for the duty ratio between 0 and A% according to a discharging efficiency of the battery pack, and 0<A%≤100%.

19. The computer device according to claim 18, wherein the second temperature interval [T3, T4] comprises a I type of the second temperature interval and a II type of the second temperature interval;
said stopping operation of the battery pack in response to the current temperature of the battery pack exceeding a second temperature interval [T3, T4] comprises:
stopping the operation of the battery pack in response to the current temperature of the battery pack exceeding the I type of the second temperature interval or the II type of the second temperature interval, wherein the I type of the second temperature interval comprises the I type of the first temperature interval of the battery pack, the battery pack is safely charged in the I type of the second temperature interval; and the II type of the second temperature interval comprises the II type of the first temperature interval of the battery pack, and the battery pack is safely discharged within the II type of the second temperature interval.

20. A non-transitory storage medium comprising computer executable instructions, wherein when executed by a computer processor, the computer executable instructions are configured to perform a fan control method according to claim 1.
